(19) United States
(12) Patent Application Publication
(10) Pub. No.: US 2026/0252459 A1
(43) Pub. Date: Aug. 27, 2026

(54) SYSTEM VERIFICATION APPARATUS, SYSTEM VERIFICATION METHOD, AND COMPUTER READABLE RECORDING MEDIUM

(71) Applicant: NEC Corporation, Minato-ku, Tokyo (JP)

(72) Inventors: Kazuki TANABE, Tokyo (JP); Takayuki KURODA, Tokyo (JP)

(73) Assignee: NEC Corporation, Minato-ku, Tokyo (JP)

(21) Appl. No.: 18/871,208

(22) PCT Filed: Jun. 23, 2022
(86) PCT No.: PCT/JP2022/025029

§ 371 Date: Dec. 3, 2024

(51) Int. Cl. G06F 11/34

(52) U.S. Cl. CPC G06F 11/3409

(57) ABSTRACT

A system verification apparatus includes: a performance-prediction-formula generation unit that generates a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and a verification-result determination unit that calculates a performance prediction value corresponding to the quantitative requirement using the performance prediction formula and a performance measurement value to be used in the performance prediction formula, and determines whether or not the calculated performance prediction value satisfies the performance defined by the abstract portion.

### TECHNICAL FIELD

The present disclosure relates to a system verification apparatus and a system verification method to be used for system verification, and further relates to a computer readable recording medium that includes recorded thereon a program for realizing the system verification apparatus and the system verification method.

### BACKGROUND ART

Upon designing an Information Communication Technology (ICT) system, a designer first creates, in the process of defining requirements, information (system requirements) that indicates an ICT system configuration including concrete and abstract elements, and that is obtained by compiling client requirements and demands.

The ICT system configuration can be represented by a graph based on a concept such as intent-based networking (IBN). In the graph, each element (component) included in the ICT system configuration is represented using a node or an edge. For example, a node is a component representing a device, an application, or the like. An edge is a component representing a connection relationship between two nodes, or the like.

Next, information (concrete system configuration) indicating a deployable ICT system configuration is derived by concretizing an abstract portion included in the system requirements based on concretization rules that are created in advance.

The concretization rules are information used to gradually concretize and convert the abstract portion into a concrete portion. However, the abstract portion may be converted into a concrete portion by one instance of conversion.

The concrete portion indicates a component or configuration that has been definitively decided upon for actual use in the ICT system. The abstract portion indicates a component or configuration whose function has been confirmed but that is uncertain in the sense that the component or configuration to be actually used in the system has not been concretely confirmed.

As a related technique, Patent Document 1 discloses a system-configuration derivation apparatus that uses machine learning to reduce the man-hours required to design an ICT system. According to the system-configuration derivation apparatus in Patent Document 1, in a case in which concrete system configuration information (concrete system configuration) is generated from abstract configuration information (system requirements), a reward value is provided to each of the generated system configuration and concretization rules applied in the generation process, and Artificial Intelligence (AI) is trained with the reward values.

Consequently, the AI can pseudo-acquire engineers' knowledge (design knowledge) related to system design. Furthermore, by performing designing and the learning of reward values for various requirements, the design speed and reliability of system configurations can be improved.

### LIST OF RELATED ART DOCUMENTS

### Patent Document

Patent Document 1: Japanese Patent No. 6989014

### SUMMARY OF INVENTION

### Problems to be Solved by the Invention

However, according to the system-configuration derivation apparatus in Patent Document 1, a verification environment equivalent to a designed concrete system configuration is constructed in order to check that the concrete system configuration satisfies system requirements. In addition, according to the system-configuration derivation apparatus in Patent Document 1, verification programs corresponding to the respective components constituting the system requirements are created. Furthermore, according to the system-configuration derivation apparatus in Patent Document 1, the verification programs need to be executed and verified in the constructed verification environment. Accordingly, the construction of the verification environment and the creation and verification of the verification programs are expected to take a long time.

Furthermore, according to the system-configuration derivation apparatus in Patent Document 1, a vast amount of teaching data relating to quantitative requirements such as performance would be required for the AI to perform machine learning of system performance indices. Also, designing and verification would need to be repeated in order to obtain a vast amount of teaching data relating to quantitative requirements such as performance, and thus the verification is expected to take a long time.

An example object of the present disclosure is to reduce the time required to verify an ICT system.

### Means for Solving the Problems

In order to achieve the example object described above, a system verification apparatus according to an example aspect of the present disclosure includes:
a performance-prediction-formula generating unit that generates a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
a verification-result determining unit that calculates a performance prediction value corresponding to the quantitative requirement using the performance prediction formula and a performance measurement value to be used in the performance prediction formula, and determines whether or not the calculated performance prediction value satisfies the performance defined by the abstract portion.

Also, in order to achieve the example object described above, a system verification method that is performed by a computer according to an example aspect of the present disclosure includes:
generating a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculating a performance prediction value corresponding to the quantitative requirement using the performance prediction formula and a performance measurement value to be used in the performance prediction formula, and determining whether or not the calculated performance prediction value satisfies the performance defined by the abstract portion.

Furthermore, in order to achieve the example object described above, a computer-readable recording medium according to an example aspect of the present invention includes a program recorded on the computer-readable recording medium, the program including instructions that cause the computer to carry out:
generating a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculating a performance prediction value corresponding to the quantitative requirement using the performance prediction formula and a performance measurement value to be used in the performance prediction formula, and determining whether or not the calculated performance prediction value satisfies the performance defined by the abstract portion.

### Advantageous Effects of the Invention

As described above, according to the present disclosure, the time required to verify an ICT system can be reduced.

### BRIEF DESCRIPTION OF THE DRAWINGS

FIG. 1 is a diagram for describing an example of the system verification apparatus in the first example embodiment.

FIG. 2 is a diagram for describing an example of the system requirements.

FIG. 3 is a diagram for describing an example of a concrete system configuration.

FIG. 4 is a diagram for describing an example of the generation of a performance prediction formula.

FIG. 5 is a diagram for describing an example of a data structure of the performance measurement information.

FIG. 6 is a diagram for describing an example of a system including the system verification apparatus in the first example embodiment.

FIG. 7 is a diagram for describing an example of a search for execution entities and parameters.

FIG. 8 is a diagram for describing an example of a search operation.

FIG. 9 is a diagram for describing an example of verification information.

FIG. 10 is a diagram for describing an example of verification results.

FIG. 11 is a diagram for describing an example of a user interface of the design-and-evaluation tool.

FIG. 12 is a diagram for describing an example of the operations of the system verification apparatus in the first example embodiment.

FIG. 13 is a diagram illustrating an example of the system verification apparatus in the second example embodiment.

FIG. 14 is a diagram for describing an example of the operations of the component extraction unit.

FIG. 15 is a diagram for describing an example of the operations of the update determination unit.

FIG. 16 is diagram for describing an example of the operations of the system verification apparatus in the second example embodiment.

FIG. 17 is diagram for describing an example of the operations of the system verification apparatus in the second example embodiment.

FIG. 18 is a diagram for describing an example of a computer that realizes the system verification apparatus in the first and second example embodiments.

### EXAMPLE EMBODIMENT

### First Example Embodiment

In the following, an example embodiment will be described with reference to the drawings. Note that, in the drawings described in the following, the same reference symbol is provided to elements having the same function or corresponding functions, and repetitive description thereof may be omitted.

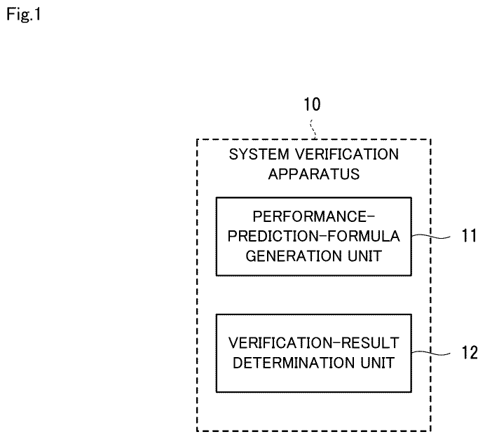

A configuration of a system verification apparatus 10 in a first example embodiment will be described. FIG. 1 is a diagram for describing an example of the system verification apparatus in the first example embodiment.

### Apparatus Configuration

The system verification apparatus 10 illustrated in FIG. 1 is an apparatus that reduces the time required to verify an ICT system. The system verification apparatus 10 includes a performance-prediction-formula generation unit 11 and a verification-result determination unit 12.

The system verification apparatus 10 uses system requirements and a concrete system configuration to verify the performance of a concrete portion of the concrete system configuration that is obtained by concretizing an abstract portion of the system requirements.

In the system requirements, requirements for an ICT system are defined by a user of the system verification apparatus 10. For example, a definition of the system requirements takes the form of information (for example, programming code or the like) including description of definitions regarding the element types of an operation system (OS) and a server computer.

Specifically, for example, the definition of the system requirements takes the form of information (programming code) including information that requires verification (information regarding verification items), etc., in addition to attribute values of configuration information such as information regarding types of elements in the ICT system, application setting information, and OS setting information.

In the definition of the system requirements, an inheritance relationship may be present among the types of elements (components) constituting the ICT system and types of relationships between the components, and an abstract type indicating the inheritance source may be included.

Specifically, for example, in regard to a windows type and a ubuntu type respectively representing a Windows OS and a Ubuntu Linux (registered trademark) OS, which are types of OSs, there is an inheritance relationship in which an abstract os type indicating an OS is the parent class and the windows type or ubuntu type is the child class, and the os type component may be included as an element in the definition of the system requirements should the user not designate the type of OS.

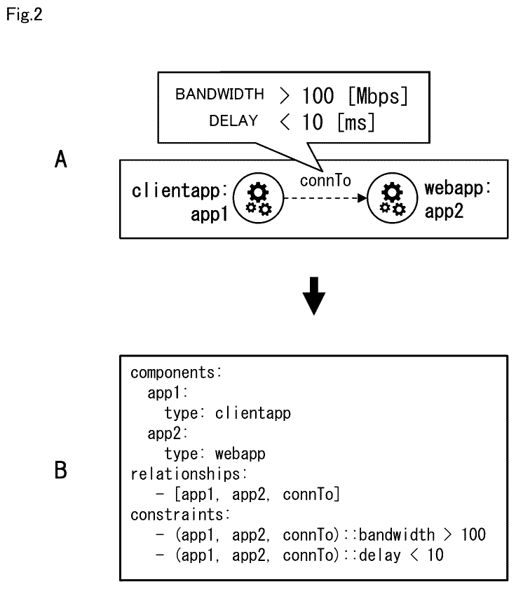

FIG. 2 is a diagram for describing an example of the system requirements. A in FIG. 2 illustrates a graph indicating components (parts) of the system requirements, and quantitative requirements of an abstract portion. B in FIG. 2 illustrates information (programming code) representing the definition of the system requirements in A in FIG. 2.

In the graph in A in FIG. 2, an abstract relationship (dashed arrow) is defined indicating that a client app type element “app1” representing a client application can access a webapp type element “app2” representing a web application executed on a web server with a bandwidth greater than 100 megabits per second (hereinafter “Mbps”) and with a delay less than 10 milliseconds (hereinafter “ms”).

The programming code in B in FIG. 2 is data representing the definition of the system requirements equivalent to the graph in A in FIG. 2, and may be created using a data structure format such as YAML or JavaScript Object Notation (JSON).

The programming code in B in FIG. 2 is formed from three fields, i.e., “components” defining system elements constituting the requirements, “relationships” defining a relationship between the elements, and “constraints” defining performance, etc.

In “relationships”, “[app1, app2, connTo]” represents a connTo type relationship indicating an abstract connection relationship from the web application app1 to the web application app2.

In “constraints”, “(app1, app2, connTo)::bandwidth>100” (verification item) indicates that the quantitative requirement “(app1, app2, connTo)::bandwidth” representing the bandwidth between the applications app1 and app2 is greater than 100 Mbps.

Similarly, in “constraints”, “(app1, app2, connTo)::delay<10” (verification item) indicates that the quantitative requirement “(app1, app2, connTo)::delay” representing the delay between the applications app1 and app2 is less than 10 ms.

Note that quantitative requirements are not limited to the bandwidth and delay described above. Furthermore, the performances relating to individual quantitative requirements (non-functional requirements) are not limited to the bandwidth performance and delay performance described above.

One or more concrete system configurations are generated for the system requirements. The above-described concrete system configuration is one of the one or more concrete system configurations that are generated.

In the first example embodiment, system requirements and one concrete system configuration obtained by concretizing the system requirements are inputted to the system verification apparatus 10 as a set.

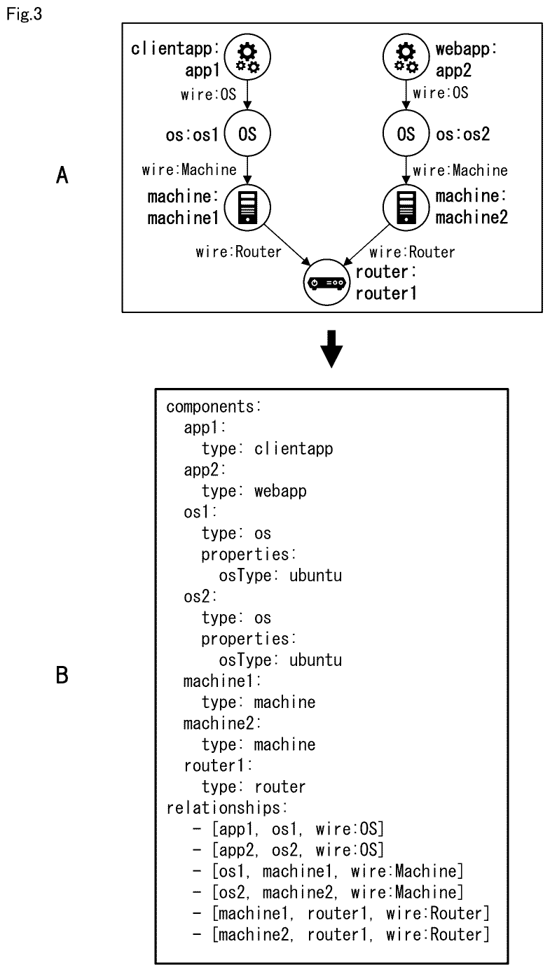

FIG. 3 is a diagram for describing an example of a concrete system configuration. A in FIG. 3 is a graph illustrating a configuration of a concrete system configuration. That is, the graph does not include any abstract portions. B in FIG. 3 illustrates information (programming code) representing a definition of the concrete system configuration.

For example, the definition of the concrete system configuration may include attribute values of configuration information such as information regarding types of elements, application setting information, and OS setting information.

Specifically, an ubuntu type component representing a Ubuntu Linux OS includes an attribute value “version” regarding a designation of OS version, and one of character strings such as “20.04”, “21.10”, and “22.04” indicating versions of the OS is defined as the “version” value.

The graph in A in FIG. 3 indicates a configuration in which, in order to realize communication between applications app1 and app2, the applications are each executed on an OS on a separate physical machine, and the physical machines are connected to one another via a router.

The applications app1 and app2 are respectively connected to OS type components os1 and os2 representing OSs via wire: OS type relationships (solid arrows) representing application host relationships on the OSs. Furthermore, in os1 and os2, an attribute value “os Type: ubuntu” indicating the use of Ubuntu Linux (registered trademark) is stored as the OS type.

Similarly, the OS type components os1 and os2 are respectively connected to machine type components machine1 and machine2 representing physical machines via wire: Machine type relationships (solid arrows) representing the execution of the OSs on the machines. Furthermore, the physical machines machine1 and machine2 are respectively connected to a router type component router1 representing a router via wire: Router type relationships (solid arrow) representing network connection to the router.

The performance-prediction-formula generation unit 11 generates a performance prediction formula for determining whether or not, in a concrete system configuration obtained by concretizing system requirements including an abstract portion, a performance of a concrete portion (verification item) that is obtained by concretizing the abstract portion satisfies a performance defined by the abstract portion based on information set in advance with respect to a quantitative requirement of components included in the concrete portion.

Specifically, the performance-prediction-formula generation unit 11 first acquires a set of system requirements and a concrete system configuration from a storage device. Next, the performance-prediction-formula generation unit 11 generates a performance prediction formula for verifying a performance of a concrete portion (verification item) of the concrete system configuration obtained by concretizing an abstract portion of the system requirements.

Next, the performance-prediction-formula generation unit 11 refers to later-described performance measurement information that has been generated in advance and stored in the storage device and acquires, from the performance measurement information, performance measurement values to be used in the performance prediction formula. However, the acquisition of the performance measurement values to be used in the performance prediction formula may be performed by the verification-result determination unit 12.

The generation of a performance prediction formula will be described.

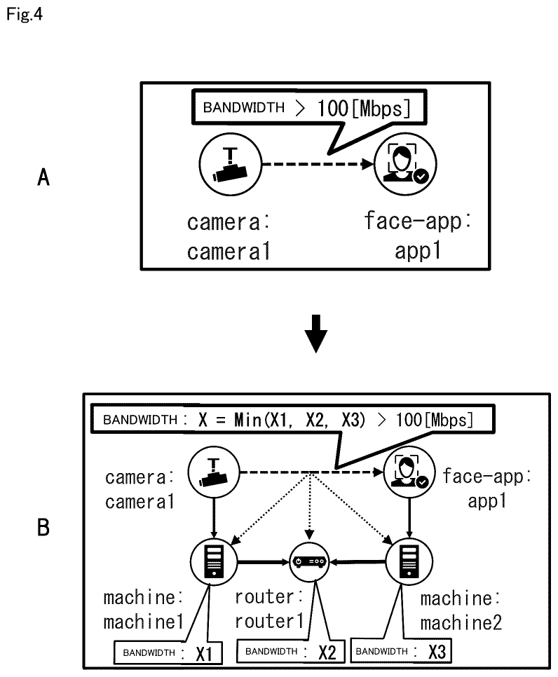

FIG. 4 is a diagram for describing an example of the generation of a performance prediction formula. In the graph in A in FIG. 4, as system requirements, it is defined that the bandwidth of communication from a camera type component cameral representing a camera and a face-app type component app1 representing a face recognition application is greater than 100 Mbps.

The graph in B in FIG. 4 is one of concrete system configurations generated by concretizing an abstract portion of the system requirements illustrated in A in FIG. 4. Note that, for example, it is conceivable to execute the concretization of the abstract portion using the learning-type automated system design technique disclosed in Patent Document 1 described above, or the like.

Specifically, the graph in B in FIG. 4 includes a machine type component machine1, a machine type component machine2, and a router type component router1. The machine type component machine1 represents a physical machine connected to the camera. The machine type component machine2 represents a physical machine on which the face recognition application is executed. The router type component router 1 represents a router that connects the physical machines.

Furthermore, the graph in B in FIG. 4 includes a relationship (solid arrow) between the machine type component machine1 and the router type component router1, and a relationship (solid arrow) between the router type component router1 and the machine type component machine2. Note that the graph in B in FIG. 4 is illustrated as a result obtained by concretizing the abstract (dashed arrow) relationship between the camera and the face recognition application in the system requirements.

Furthermore, when an abstract portion is concretized (when concretization processing is executed), as a history of concretization of the abstract portion, information in which information representing the abstract portion and information representing the concrete portion (information representing the relation with components and relationships) are associated is recorded to the storage device as a concretization history.

A concretization history is information indicating abstract components and an abstract relationship to which concretization rules have been applied to generate components and relationships included in a concrete system configuration in the process of designing the concrete system configuration from system requirements, and is recorded in each of the components and relationships. In the example in B in FIG. 4, the relationship “(app1, app2, connTo)” is recorded as a concretization history of each of the components machine1, machine2, and router1. Thus, it is indicated that three components have been generated by concretizing the abstract relationship “(app1, app2, connTo)”.

Furthermore, the performance of the abstract portion (dashed line) in the graph in A in FIG. 4 is defined as a bandwidth greater than 100 Mbps (“bandwidth>100 Mbps”). In the graph in B in FIG. 4, “bandwidth: X=Min(X1, X2, X3) >100 Mbps” is indicated as a performance prediction formula for predicting the performance of the concrete portion corresponding to the above-described abstract portion (dashed line).

In the example in FIG. 4, the performance-prediction-formula generation unit 11 first refers to the above-described concretization history to detect the concretized component types and determine that the abstract relationship between camera1 and app1 is realized by the three components machine1, machine2, and router1.

Next, the performance-prediction-formula generation unit 11 generates the performance prediction formula for obtaining the performance prediction value X, according to which the minimum value among a bandwidth-related performance measurement value of machine1, a bandwidth-related performance measurement value of router1, and a bandwidth-related performance measurement value of machine2 is determined as the communication bandwidth between camera1 and app1.

Specifically, in the example in FIG. 4, because the quantitative requirement is bandwidth, a mathematical formula for generating a bandwidth-related performance prediction formula is selected from among determination rules stored in the storage device in advance. The determination rules are pieces of information in each of which a quantitative requirement and a function are associated with one another.

In the example in FIG. 4, because the quantitative requirement is bandwidth, the performance-prediction-formula generation unit 11 selects the function Min() as a mathematical formula for selecting the minimum value. Note that the mathematical formula that is selected differs depending on the type of quantitative requirement.

As types of other functions, Max() for selecting the maximum value among arguments, Sum() for calculating the total sum of argument values, Average() for calculating the average of argument values, etc., may be used.

In the mathematical formula of a performance prediction formula, performance values of components and relationships included in a concrete system configuration are set as arguments, and the function type is determined based on the type of quantitative requirement. The components and relationships the performance values of which are to be set as arguments of the function are determined by performing a recursive search, from a component or relationship with respect to which the quantitative requirement is defined, for components and relationships including the component or relationship in the concretization history, and adding components and relationships of types that are defined in advance with respect to each type of quantitative requirement.

In the example in B in FIG. 4, the function Min(X1, X2, X3) is generated as the performance prediction formula of the bandwidth X between the applications app1 and app2 by: searching for elements that include, in the concretization history thereof, the relationship (app1, app2, connTo) with respect to which the quantitative requirement of bandwidth is defined; and adding, as arguments of the function Min() for the prediction of bandwidth performance, the variables X1, X2, and X3 indicating the performance values of machine1, router1, and machine2, which are machine-type and router-type elements defined as elements for which arguments are to be added in the prediction of bandwidth performance.

In such a manner, the performance-prediction-formula generation unit 11 generates the performance prediction formula “X=Min(X1, X2, X3)>100 Mbps”. Note that, in the performance prediction formula, X1 is a variable representing the bandwidth-related performance measurement value of machine1. X2 is a variable representing the bandwidth-related performance measurement value of machine2. X3 is a variable indicating the bandwidth-related performance measurement value of router1.

The verification-result determination unit 12 acquires the performance measurement values to be used in the performance prediction formula, calculates a performance prediction value of the quantitative requirement using the acquired performance measurement values and the performance prediction formula, and determines whether or not the calculated performance prediction value satisfies the performance defined by the abstract portion.

Then, in order to generate a verification result, the verification-result determination unit 12 outputs, to an output-information generation unit 16, the concrete system configuration, the verification item, the performance prediction value, and the determination result.

Note that the acquisition of the performance measurement values to be used in the performance prediction formula may be performed by the verification-result determination unit 12 or the performance-prediction-formula generation unit 11.

Specifically, the verification-result determination unit 12 first acquires, from the performance measurement information, the measurement value of the bandwidth performance “bandwidth” of the machine type component, the measurement value of the bandwidth performance “bandwidth” of the router type component, and the measurement value of the bandwidth performance “bandwidth” of the machine-type component to be respectively assigned to the variables X1, X2, and X3 included in the performance prediction formula “X=Min(X1, X2, X3)>100 Mbps”.

Next, the verification-result determination unit 12 calculates a performance prediction value by assigning the measurement values to the variables X1, X2, and X3.

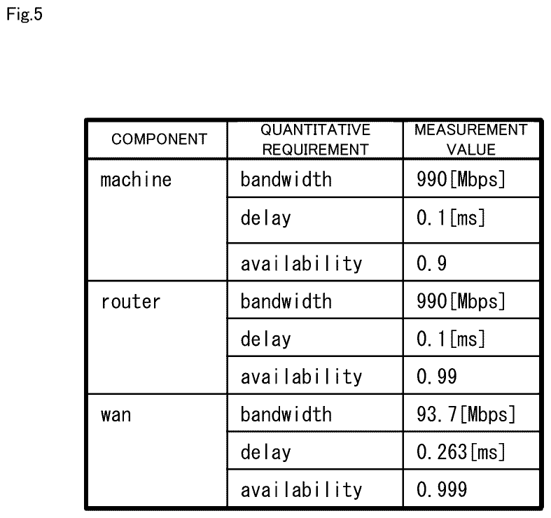

FIG. 5 is a diagram for describing an example of a data structure of the performance measurement information. In the example in FIG. 5, the performance measurement information is information in which components, quantitative requirements, and measurement values are associated with one another. Specifically, the performance measurement information is information in which information indicating types of components, information indicating types of quantitative requirements, and measurement values are associated with one another.

In the example in FIG. 5, a quantitative requirement “bandwidth” indicating bandwidth and “990 Mbps” indicating a performance measurement value of bandwidth are associated with a machine type component indicating a physical machine. However, the indication of unit need not be included.

Furthermore, in the example in FIG. 5, a quantitative requirement “delay” indicating delay and “0.1 ms” indicating a performance measurement value of delay are associated with the machine type component indicating a physical machine. However, the indication of unit need not be included.

Also, in the example in FIG. 5, a quantitative requirement “availability” indicating availability and “0.9” indicating a performance measurement value of availability are associated with the machine type component indicating a physical machine.

In such a manner, in the first example embodiment, a performance prediction value of a quantitative requirement can be calculated using a performance prediction formula and performance measurement values of ICT system components that are stored (accumulated) in advance in a storage device, and it can be determined whether or not the calculated performance prediction value satisfies the performance defined by an abstract portion.

Thus, according to the first example embodiment, performance can be verified in a short amount of time because the construction of a verification environment, the creation of a verification program, and verification can be skipped. Furthermore, the working time of an engineer can be reduced (burden can be alleviated).

### System Configuration

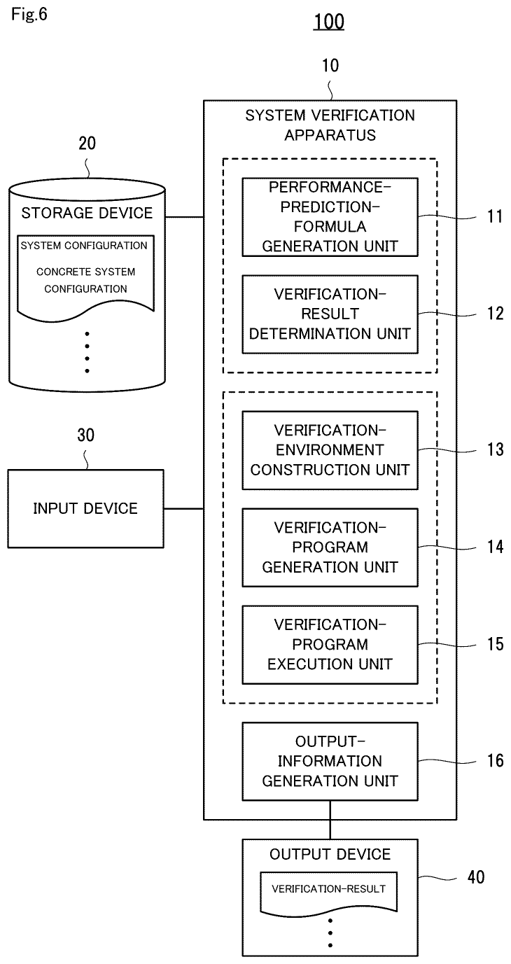

Next, the configuration of the system verification apparatus 10 in the example embodiment will be described in detail with reference to FIG. 6. FIG. 6 is a diagram for describing an example of a system including the system verification apparatus in the first example embodiment.

A system 100 at least includes the system verification apparatus 10, a storage device 20, an input device 30, and an output device 40. The system verification apparatus 10, the storage device 20, the input device 30, and the output device 40 are communicably connected via a network.

For example, the system verification apparatus 10 is a central processing unit (CPU), a programmable device such as a field-programmable gate array (FPGA), a graphics processing unit (GPU), or a circuit or an information processing apparatus, such as a server computer, a personal computer, or a mobile terminal, having one or more of a CPU, a programmable device, and a GPU installed therein.

The storage device 20 is a database, a server computer, a circuit including a memory, or the like. The storage device 20 stores therein at least the following information. For example, the storage device 20 at least stores therein information such as: the system requirements; the concrete system configuration; the definition of the types of components and relationships in the system; the concretization rule; the determination rules; the concretization history; and a verification program generation template.

While the storage device 20 is provided outside the system verification apparatus 10 in the example in FIG. 6, the storage device 20 may be provided inside the system verification apparatus 10. Furthermore, the storage device 20 may be formed from a plurality of storage devices, and the above-described information may be stored so as to be distributed among the plurality of storage devices.

For example, the input device 30 is a device such as a keyboard, a mouse, and/or a touch panel. The input device 30 is used to operate the system verification apparatus 10, the output device 40, etc.

The output device 40 acquires the later-described output information, which has been converted into an outputtable format by the later-described output-information generation unit 16, and outputs image(s), sound, etc., generated based on the output information. For example, the output device 40 is an image display device in which liquid crystal, organic electroluminescence (EL), or a cathode ray tube (CRT) is used, or the like. Furthermore, the image display device may include a sound output device such as a speaker or the like, etc. Note that the output device 40 may be a printing device such as a printer.

For example, the communication network is a conventional network that is constructed using a communication line such as the Internet, a Local Area Network (LAN), a dedicated line, a telephone line, an enterprise intranet, a mobile communication network, Bluetooth (registered trademark), or Wireless Fidelity (WiFi).

### System Verification Apparatus

The system verification apparatus will be described in detail. The system verification apparatus 10 in the first example embodiment includes the performance-prediction-formula generation unit 11, the verification-result determination unit 12, a verification-environment construction unit 13, a verification-program generation unit 14, a verification-program execution unit 15, and the output-information generation unit 16.

Note that, because the performance-prediction-formula generation unit 11 and the verification-result determination unit 12 have been described above, description of the performance-prediction-formula generation unit 11 and the verification-result determination unit 12 is omitted.

The verification-environment construction unit 13 constructs a verification environment defined by a concrete system configuration if the performance-prediction-formula generation unit 11 cannot acquire performance measurement values from the performance measurement information.

Specifically, first, the verification-environment construction unit 13 acquires, from the performance-prediction-formula generation unit 11, a determination result that was generated by the performance-prediction-formula generation unit 11 upon generating a performance prediction formula and that indicates whether or not performance measurement values included in a concrete portion corresponding to an abstract portion were included in the performance measurement information.

Next, if the determination result indicates that the performance measurement value were not included in the performance measurement information, the verification-environment construction unit 13 constructs a verification environment based on the definition of the concrete system configuration in order to perform performance measurement of the performance measurement values that could not be acquired. For example, the verification environment is preferably constructed on a virtual environment or the like.

The verification-program generation unit 14 generates a verification program for executing performance measurement processing in the verification environment constructed by the verification-environment construction unit 13. For example, the verification-program generation unit 14 generates the verification program using the technique disclosed in Japanese Patent Laid-Open Publication No. 2021-165930, or the like. However, there is no limitation to this technique.

Specifically, the verification-program generation unit 14 acquires a quantitative requirement and the concrete system configuration, and generates a verification program to be executed in the verification environment by referring to a preset template corresponding to the type of the quantitative requirement and adjusting execution entities and parameters of the verification program by performing a search in a draft-configuration graph structure.

The template uses the type of the quantitative requirement as a key, and defines the types of commands required to verify the quantitative requirement, and a procedure for performing a search in the draft-configuration graph structure for the execution entities and parameters required to execute the commands.

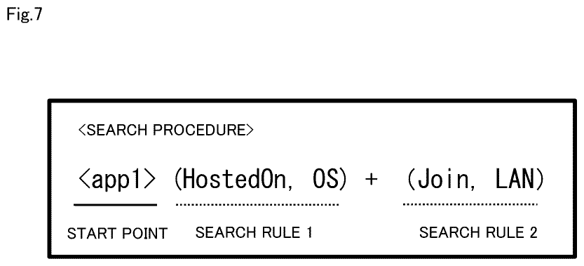

FIG. 7 is a diagram for describing an example of a search for execution entities and parameters. The search procedure illustrated in FIG. 7 is formed from a search start point indicated between the symbols “<>”, and search rules 1 and 2 indicated so as to be separated by the symbol “+”.

The search is executed in the order of search rule 1 and then search rule 2. In the example in FIG. 7, in regard to a graph structure of a concrete system configuration, the search procedure “<app1>(HostedOn, OS) +(Join, LAN)” means that: starting from the component app1 node as the start point of the search, edges representing the relationship HostedOn are to be repeatedly followed one or more times; starting from the OS type component node that is initially reached, edges representing the relationship Join are to be repeatedly followed one or more times; and the LAN type component node that is initially reached is to be adopted as the search result.

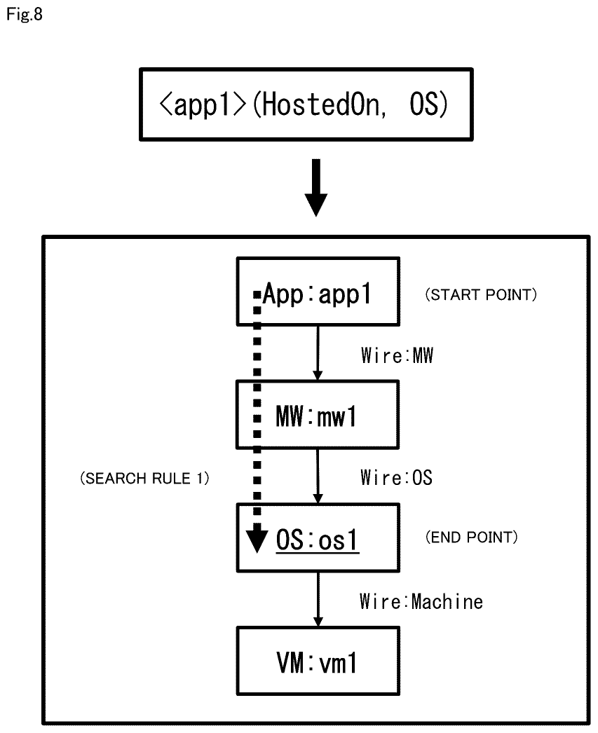

FIG. 8 is a diagram for describing an example of a search operation. With reference to FIG. 8, a method for searching for an execution entity of an application component app1 included in a concrete system configuration, and a search operation in the structure of the concrete system configuration will be described.

In the example in FIG. 8, in accordance with the definition “<app1>(HostedOn, OS)” of a search procedure, “Wire:MW” and “Wire:OS”, which are relationship edges inherited from the “HostedOn” type, are followed starting from the component app1 node, and the search ends with the end point being the OS1 node, which is an OS type component and is output as the search result.

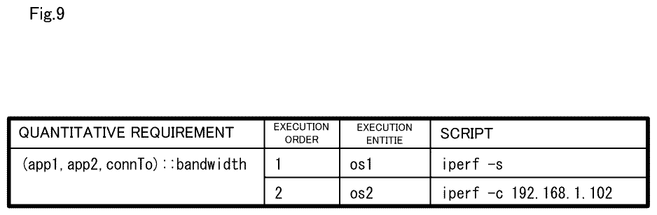

FIG. 9 is a diagram for describing an example of verification information. A verification program is programming code including information required for verification (verification information) such as that illustrated in FIG. 9. In the verification information, a quantitative requirement, a quantitative requirement execution order, execution entities, and scripts for verifying the quantitative requirement are stored in association with one another.

The verification-program execution unit 15 executes the verification program generated by the verification-program generation unit 14, and outputs information (performance measurement result) indicating the result of execution of the verification program. Specifically, the verification-program execution unit 15 first executes the verification program in the verification environment, and generates a performance measurement result in which components, a quantitative requirement of the components, and performance measurement values of the quantitative requirement are associated with one another.

Next, the verification-program execution unit 15 adds (stores) the output performance measurement result to the performance measurement information in the storage device 20. Note that the output performance measurement result is used by the verification-result determination unit 12 to calculate a performance prediction value.

The output-information generation unit 16 acquires, from the verification-result determination unit 12, information that is required to generate a verification result (at least a concrete system configuration, a verification item, a performance prediction value, and a determination result), generates output information for outputting the verification result to the output device 40, and outputs the output information to the output device 40.

Note that, besides the verification result, the output-information generation unit 16 generates and outputs, to the output device 40 as output information, a user interface screen of an ICT system design-and-evaluation tool, for example.

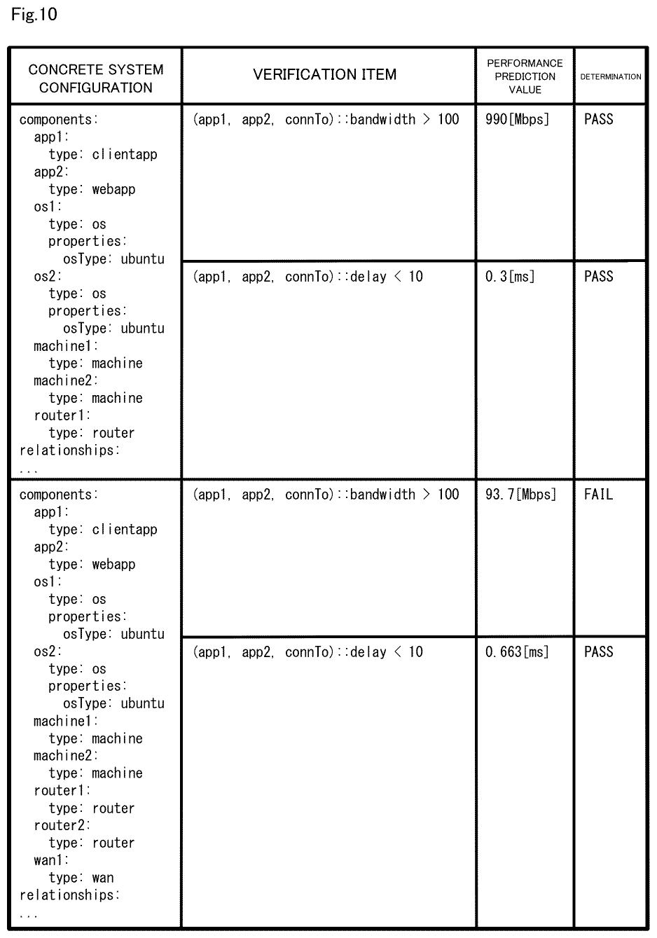

FIG. 10 is a diagram for describing an example of verification results. A verification result includes description of a verification result of a concrete system configuration. FIG. 10 illustrates information in which, for each of the plurality of concrete system configurations generated by concretizing the system requirements illustrated in FIG. 2, verification items, performance prediction values corresponding to the verification items, and determination results of the verification items are associated with one another.

The first programming code in “concrete system configuration” in FIG. 10 corresponding to the concrete system configuration illustrated in FIG. 3. Furthermore, a verification item “(app1, app2, connTo)::bandwidth>100” representing a bandwidth constraint and a verification item “(app1, app2, connTo)::delay<10” representing a delay constraint are associated with the first programming code.

A verification result “990 Mbps” and a determination result “PASS” indicating that the bandwidth constraint condition has been satisfied are associated with the verification item representing the bandwidth constraint. Furthermore, a verification result “0.3 ms” for the verification item representing the delay constraint and a determination result “PASS” indicating that the delay constraint condition has been satisfied are associated with one another.

Subsequently, the next programming code in “concrete system configuration” in FIG. 10 represents a configuration in which the physical machine machine1 on which the application app1 is executed and the physical machine machine2 on which the application app2 is executed are connected via a wan type component wan1 indicating an Internet line, and, while the constraint condition is satisfied for the verification item “(app1, app2, connTo)::delay<10”, the verification result for the verification item “(app1, app2, connTo)::bandwidth>100” is 93.7 Mbps and does not satisfy the constraint condition, and a “FAIL” determination meaning that the verification item is unsatisfied has been established.

### Design-and-Evaluation Tool

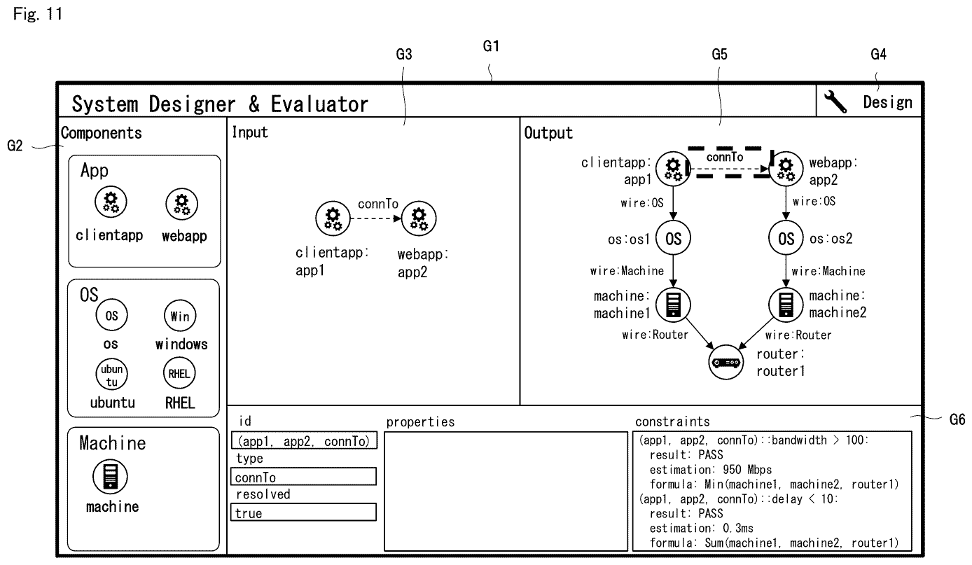

The design-and-evaluation tool will be described with reference to FIG. 11. The design-and-evaluation tool (software program) provided in the system verification apparatus 10 is used to generate concrete system configurations from the above-described system requirements.

FIG. 11 is a diagram for describing an example of a user interface of the design-and-evaluation tool. The screen display G1 in FIG. 11 indicates a graphical user interface (GUI) screen. For example, the user is a designer who is designing a system.

The screen display G1 is formed from a library display section G2, an input form G3, a design button G4, an output form G5, and a subwindow (detailed-information display section) G6.

For example, in the library display section G2, types of ICT system components used in the system verification apparatus 10, system design (the learning-type automated system design technique disclosed in Patent Document 1), etc., are arranged and displayed by different categories such as App (application), OS, Machine, etc.

The input form G3 is used to generate a graph indicating system requirements. For example, the user operates the input device 30 and creates the system requirements graph shown in the input form G3 in FIG. 11. Specifically, the user creates a system requirements graph by selecting component nodes from the library display section G2 and arranging the selected nodes in the input form G3.

If the design button G4 is pressed after system requirements have been created using the input form G3, a concrete system configuration is generated using the above-described learning-type automated system design technique, etc.

The output form G5 displays the concrete system configuration that is the design result. For example, when the user operates the input device 30 and selects a node (component) or an edge (relationship) in the system requirements graph displayed in the input form G3 or the concrete system configuration graph displayed in the output form G5, detailed information of the selected component or relationship is displayed in the subwindow G6.

The example in FIG. 11 indicates that the relationship (app1, app2, connTo) included in the concrete system configuration illustrated in FIG. 3, which is a design result of the system requirements illustrated in FIG. 2, has been selected.

The subwindow G6 displays information regarding components and relationships between components included in the system requirements and the concrete system configuration. Specifically, an ID of the selected element is displayed in the “id” field, and the name of the type of the selected element is displayed in the “type” field. The “resolved” field is a flag indicating that the selected component has been replaced with a concrete configuration in the design process of the learning-type automated system design technique and does not exist in the actual configuration.

The “properties” field displays information about an attribute value of the selected element, and the “constraints” field displays verification items including quantitative requirements and information equivalent to verification results illustrated in FIG. 10.

In the example in FIG. 11, as the verification result for the verification item “(app1, app2, conn To)::bandwidth>100” indicating the bandwidth constraint between applications, “PASS” is registered as the value of “result” indicating whether or not the verification item is satisfied.

Furthermore, “950 Mbps” calculated by the system verification apparatus 10 is registered as the value of “estimation” indicating the performance prediction value of the component, and the value “Min(machine1, machine2, router1)” of “formula” indicating the performance prediction formula indicates that the minimum value among the performance measurement values of the physical machine components machine1 and machine2, and the router component “router1” in the concrete system configuration is used as the performance prediction value.

### Apparatus Operations

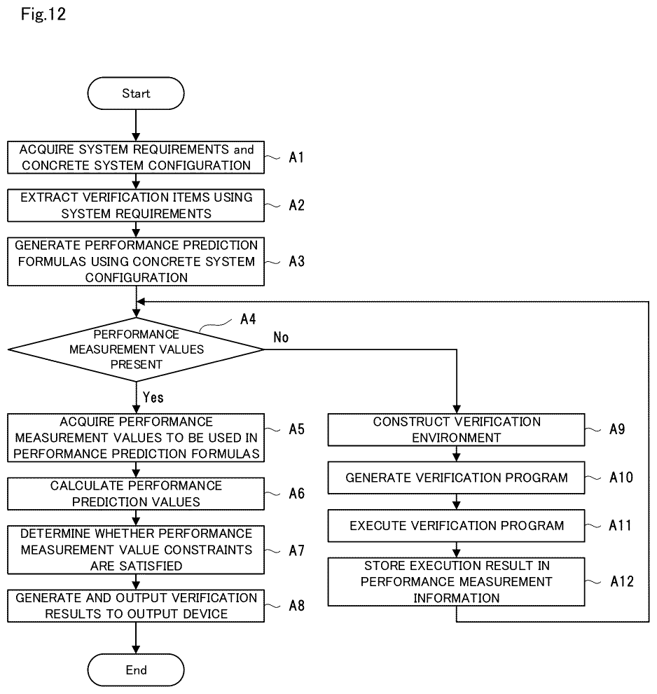

Next, operations of the system verification apparatus 10 in the first example embodiment will be described with reference to FIG. 12. FIG. 12 is a diagram for describing an example of the operations of the system verification apparatus in the first example embodiment. Drawings will be referred to as needed in the following description. Furthermore, in the first example embodiment, a system verification method is implemented by causing the system verification apparatus to operate. Accordingly, the following description of the operations performed by the system verification apparatus is substituted for the description of the system verification method in the first example embodiment.

First, the performance-prediction-formula generation unit 11 acquires a set of system requirements and a concrete system configuration from the storage device 20 (step A1).

Next, the performance-prediction-formula generation unit 11 extracts a concrete portion (verification items) of the concrete system configuration that is obtained by concretizing an abstract portion of the system requirements (step A2). Next, the performance-prediction-formula generation unit 11 generates performance prediction formulas for verifying the performance of the verification items (step A3).

Next, the performance-prediction-formula generation unit 11 refers to the performance measurement information stored in the storage device 20, and, if performance measurement values to be used in the performance prediction formulas are stored in the performance measurement information (Step A4: Yes), the performance-prediction-formula generation unit 11 acquires the performance measurement values to be used in the performance measurement formulas from the performance measurement information (step A5). However, the acquisition of the performance measurement values to be used in the performance prediction formulas may be performed by the verification-result determination unit 12.

Next, the verification-result determination unit 12 acquires the performance measurement values to be used in the performance prediction formulas, and calculates performance prediction values of the quantitative requirements using the acquired performance measurement values and the performance prediction formulas (step A6). Next, the verification-result determination unit 12 determines whether or not the calculated performance prediction values satisfy the performance defined by the abstract portion (whether or not the performance measurement values satisfy constraints) (step A7).

Then, in order to generate verification results, the verification-result determination unit 12 outputs, to the output-information generation unit 16, at least the concrete system configuration, the verification items, the performance prediction values, and the determination results.

Next, the output-information generation unit 16 acquires, from the verification-result determination unit 12, information that is required to generate verification results, generates output information to be output to the output device 40, and outputs the generated output information to the output device 40 (step A8).

Furthermore, the performance-prediction-formula generation unit 11 refers to the performance measurement information stored in the storage device 20, and, if performance measurement values to be used in a performance prediction formula is not stored in the performance measurement information (step A4: No), the verification-environment construction unit 13 constructs the environment defined by the concrete system configuration (step A9).

Next, the verification-program generation unit 14 generates a verification program for executing performance measurement processing in the environment constructed by the verification-environment construction unit 13 (step A10).

Next, the verification-program execution unit 15 executes the verification program generated by the verification-program generation unit 14 (step A11), outputs information (a performance measurement result) indicating an execution result of the verification program, and adds (stores) the output performance measurement result to the performance measurement information (step A12). Then, processing transitions to the processing in step A4.

### Effects of First Example Embodiment

According to the first example embodiment, a performance prediction value of a quantitative requirement can be calculated using a performance prediction formula and performance measurement values of ICT system components that are stored (accumulated) in advance in a storage device, and it can be determined whether or not the calculated performance prediction value satisfies a performance defined by an abstract portion.

Thus, performance can be verified in a short amount of time because the construction of a verification environment, the creation of a verification program, and verification can be skipped. Furthermore, the working time of an engineer can be reduced (burden can be alleviated).

### Program

The program according to the first example embodiment may be a program that causes a computer to execute steps A1 to A12 shown in FIG. 12. By installing this program in a computer and executing the program, the system verification apparatus and the system verification method according to the first example embodiment can be realized. Further, the processor of the computer performs processing to function as the performance-prediction-formula generation unit 11, the verification-result determination unit 12, a verification-environment construction unit 13, a verification-program generation unit 14, a verification-program execution unit 15, and the output-information generation unit 16.

Also, the program according to the first example embodiment may be executed by a computer system constructed by a plurality of computers. In this case, for example, each computer may function as any of the performance-prediction-formula generation unit 11, the verification-result determination unit 12, a verification-environment construction unit 13, a verification-program generation unit 14, a verification-program execution unit 15, and the output-information generation unit 16.

### Second Example Embodiment

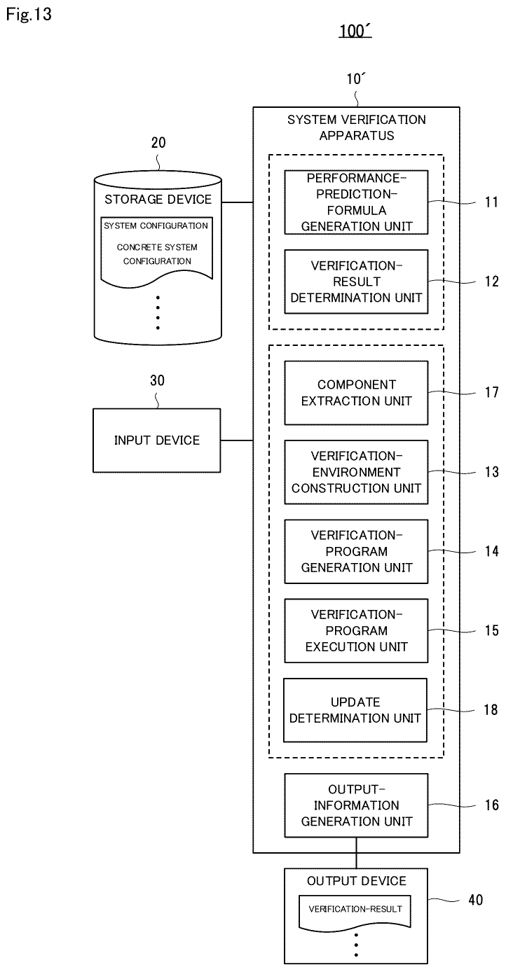

A configuration of a system verification apparatus 10′ in a second example embodiment will be described. FIG. 13 is a diagram illustrating an example of the system verification apparatus in the second example embodiment.

### Apparatus Configuration

The system verification apparatus 10′ illustrated in FIG. 13 includes the performance-prediction-formula generation unit 11, the verification-result determination unit 12, the verification-environment construction unit 13, the verification-program generation unit 14, the verification-program execution unit 15, the output-information generation unit 16, a component extraction unit 17, and an update determination unit 18.

The component extraction unit 17 first acquires, with a certain probability, a concrete system configuration acquired by the performance-prediction-formula generation unit 11, and extracts one component included in the acquired concrete system configuration.

Specifically, for each concrete system configuration acquired by the performance-prediction-formula generation unit 11, the component extraction unit 17 performs, with a predefined probability (for example, 5%, 10%, or the like), a determination of whether the concrete system configuration is to be used as a component extraction target, and extracts one component from the concrete system configuration determined as being the extraction target.

Next, the component extraction unit 17 refers to the performance measurement information in the storage device 20 to acquire a list of quantitative requirements relating to the extracted component, and outputs, to the verification-environment construction unit 13, information in which the acquired concrete system configuration and the list of quantitative requirements are associated with one another.

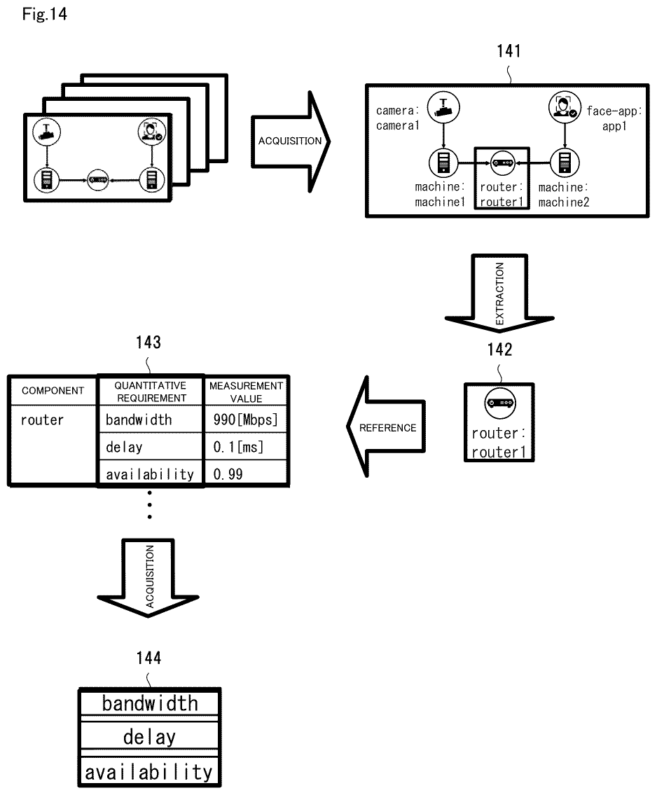

FIG. 14 is a diagram for describing an example of the operations of the component extraction unit. In the example in FIG. 14, the component extraction unit 17 first acquires, with a certain probability, a concrete system configuration 141 (equivalent to the concrete system configuration in FIG. 6) from the performance-prediction-formula generation unit 11.

Next, the component extraction unit 17 randomly extracts a component included in the concrete system configuration 141. In the example in FIG. 14, router1 that is a router type component 142 is extracted.

Next, the component extraction unit 17 refers to the performance measurement information 143 in the storage device 20, and acquires, as quantitative requirements to be verified, a quantitative requirement “bandwidth” indicating bandwidth, a quantitative requirement “delay” indicating delay, and a quantitative requirement “availability” indicating availability, which are quantitative requirements corresponding to the extracted router type component 142.

The component extraction unit 17 outputs and inputs, to the verification-environment construction unit 13, the concrete system configuration 141, the component 142, and a quantitative requirement list 144 acquired and extracted according to the above-described procedure.

The update determination unit 18 first acquires performance measurement results executed by the verification-program execution unit 15. A performance measurement result is an execution result of a verification program for verifying a quantitative requirement of components. Furthermore, a performance measurement result is a set of components, a quantitative requirement, and performance measurement values.

Next, the update determination unit 18 determines whether or not performance measurement values corresponding to the quantitative requirements of the acquired component and performance measurement values corresponding to the quantitative requirements of the same component as the acquired component that are included in the performance measurement information stored in advance in the storage device 20 meet predefined update criteria.

Next, if the performance measurement values meet the update criteria, the update determination unit 18 updates the performance measurement values corresponding to the quantitative requirements of the same component as the acquired component included in the performance measurement information that are stored in the storage device 20 with the performance measurement values corresponding to the quantitative requirements of the acquired component.

Note that, if performance measurement values corresponding to the acquired component and quantitative requirements are not recorded in the performance measurement information in the storage device 20, the performance measurement values corresponding to the acquired component are added (recorded) to the performance measurement information.

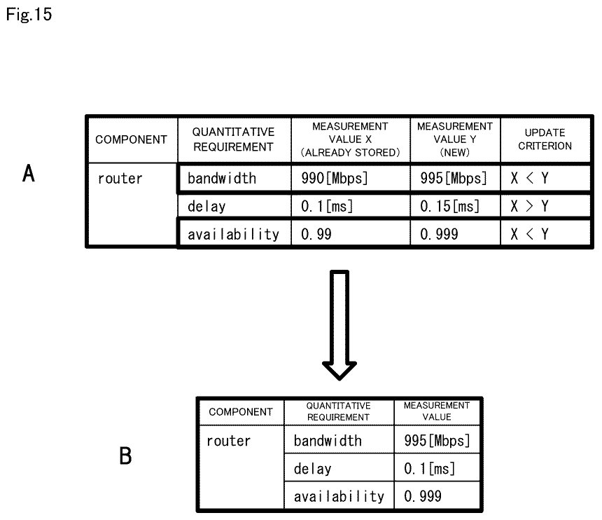

FIG. 15 is a diagram for describing an example of the operations of the update determination unit. A in FIG. 15 illustrates an operation of comparing “measurement values X” and “measurement values Y” for the component router and the quantitative requirements bandwidth, delay, and availability.

A “measurement value X” indicates a value that is already stored in the storage device 20. A “measurement value Y” indicates an execution result obtained by performing verification using the verification-program generation unit 14 and the verification-program execution unit 15 in a verification environment generated by the verification-environment construction unit 13.

An update criterion is a condition for updating (overwriting) a measurement value X with a new measurement value Y. In the example in FIG. 15, each update criterion is indicated as an inequality in which the algebraic expressions X and Y are used.

In the example in A in FIG. 15, in regard to the quantitative requirements bandwidth and availability, 990 Mbps and 0.99 are respectively stored in measurement value X and 995 Mbps and 0.999 are respectively stored in measurement value Y, and an update criterion “X<Y” indicating that the performance measurement value is to be updated if measurement value Y is greater than measurement value X is satisfied.

As illustrated in the performance measurement information in B in FIG. 15, only the performance measurement values for the quantitative requirements bandwidth and availability are updated. In contrast, in regard to the quantitative requirement delay, 0.1 ms and 0.15 ms are respectively stored in measurement value X and measurement value Y, and the performance measurement value in the performance measurement information is not updated because the update criterion “X>Y” is not satisfied.

### Apparatus Operations

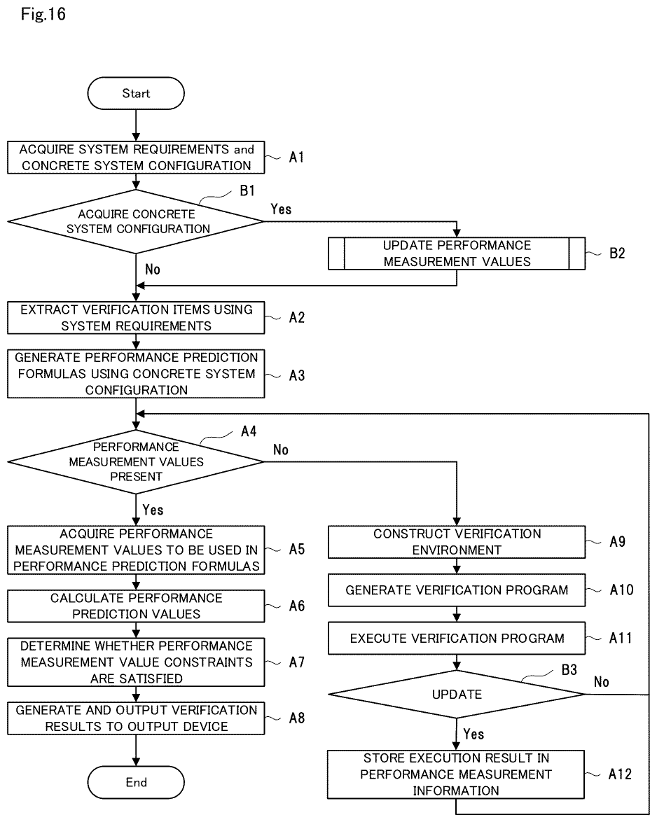

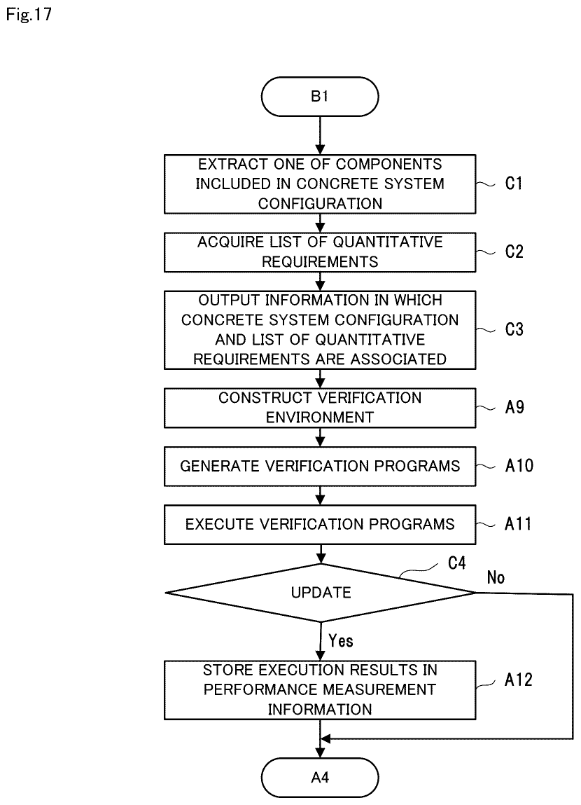

FIGS. 16 and 17 are diagrams for describing an example of the operations of the system verification apparatus in the second example embodiment. Drawings will be referred to as needed in the following description. Furthermore, in the second example embodiment, a system verification method is implemented by causing the system verification apparatus to operate. Accordingly, the following description of the operations performed by the system verification apparatus is substituted for the description of the system verification method in the second example embodiment.

Note that, in FIG. 16, the same reference symbol is provided to processing in the same step as that in FIG. 12 in the first example embodiment, and detailed description of the processing in such steps is omitted.

First, the performance-prediction-formula generation unit 11 acquires a set of system requirements and a concrete system configuration from the storage device 20 (step A1). Next, the component extraction unit 17 acquires, with a certain probability, the concrete system configuration input to the performance-prediction-formula generation unit 11 (step B1).

Next, if the component extraction unit 17 acquires the concrete system configuration (step B1: Yes), performance measurement values are updated in the processing in step B2 (step B2). Note that the performance-measurement-value update processing in step B2 may be executed asynchronously with the processing in and following step A2.

Furthermore, if the component extraction unit 17 does not acquire the concrete system configuration (step B1: No), processing transitions to the processing in step A2 and the processing in and following step A2 (processing from step A2 to A12, and B3) is executed.

Next, after a verification program is executed in step A11, the update determination unit 18 determines whether to update the performance measurement information based on the execution result of the verification program (step B3).

Specifically, in step B3, the update determination unit 18 first acquires a performance measurement result executed by the verification-program execution unit 15 (a set of components, a quantitative requirement, and performance measurement values that is the execution result of a verification program for verifying the quantitative requirement of the components).

Next, in step B3, the update determination unit 18 compares the performance measurement values of an acquired component and performance measurement values of the same component stored in the storage device 20.

Next, in a case in which updating is performed in step B3 (step B3: Yes), for each type of quantitative requirement, the update determination unit 18 updates the performance measurement value corresponding to the current component that is the same component as the acquired component using the performance measurement value corresponding to the acquired component and a predefined update criterion (step A12).

Note that, in a case in which updating is performed in step B3 (step B3: Yes), if performance measurement values corresponding to the acquired component and quantitative requirements are not recorded in the performance measurement information in the storage device 20, the update determination unit 18 adds (records) performance measurement values to the performance measurement information (step A12).

Furthermore, in a case in which updating is not performed in step B3 (step B3: No), processing is continued transitioning to step A4.

The processing in step B2 (performance-measurement-value update processing) will be described in detail.

The component extraction unit 17 first acquires, with a certain probability, the concrete system configuration input to the performance-prediction-formula generation unit 11, and extracts one component included in the acquired concrete system configuration (step C1).

Next, the component extraction unit 17 refers to the performance measurement information 143 in the storage device 20 and acquires a list of quantitative requirements relating to the extracted component (step C2), and outputs, to the verification-environment construction unit 13, information in which the acquired concrete system configuration 141 and the list of quantitative requirements are associated with one another (step C3).

Next, the verification-environment construction unit 13 constructs the environment defined by the concrete system configuration (step A9).

Next, the verification-program generation unit 14 generates verification programs for executing performance measurement processing in the environment constructed by the verification-environment construction unit 13 (step A10).

Next, the verification-program execution unit 15 executes the verification programs generated by the verification-program generation unit 14 (step A11).

Next, in a case in which updating is performed in step C4 (step C4: Yes), for each type of quantitative requirement, the update determination unit 18 updates the performance measurement value corresponding to the current component that is the same component as the acquired component using the performance measurement value corresponding to the acquired component and a predefined update criterion that is defined in advance (step A12).

Note that, in a case in which updating is performed in step C4 (step C4: Yes), if performance measurement values corresponding to the quantitative requirements of the acquired component are not recorded in the performance measurement information in the storage device 20, the update determination unit 18 adds (records) performance measurement values to the performance measurement information (step A12).

Furthermore, in a case in which updating is not performed in step B3 (step C4: No), processing transitions to step A4.

### Effects of Second Example Embodiment

According to the second example embodiment, a performance prediction value of a quantitative requirement can be calculated using a performance prediction formula and performance measurement values of ICT system components that are stored (accumulated) in advance, and it can be determined whether or not the calculated performance prediction value satisfies a performance defined by an abstract portion.

Thus, performance can be verified in a short amount of time because the construction of a verification environment, the creation of a verification program, and verification can be skipped. Furthermore, the working time of an engineer can be reduced (burden can be alleviated).

Furthermore, in regard to performance measurement values of a component in the performance measurement information, the construction of a verification environment and the measurement of performance can be executed with a certain probability, and the performance measurement value of each quantitative requirement corresponding to the component can be automatically updated according to the second example embodiment. Thus, the accuracy of performance prediction values of quantitative requirements calculated using performance prediction formulas is improved, and system performance can be verified with higher accuracy.

### Program

The program according to the second example embodiment may be a program that causes a computer to execute steps A1 to A12 and B1 to B3 shown in FIG. 16 and steps C1 to A4 shown in FIG. 17. By installing this program in a computer and executing the program, the system verification apparatus and the system verification method according to the first example embodiment can be realized. Further, the processor of the computer performs processing to function as the performance-prediction-formula generation unit 11, the verification-result determination unit 12, a verification-environment construction unit 13, a verification-program generation unit 14, a verification-program execution unit 15, and the output-information generation unit 16, the component extraction unit 17, and the update determination unit 18.

Also, the program according to the first example embodiment may be executed by a computer system constructed by a plurality of computers. In this case, for example, each computer may function as any of the performance-prediction-formula generation unit 11, the verification-result determination unit 12, a verification-environment construction unit 13, a verification-program generation unit 14, a verification-program execution unit 15, the output-information generation unit 16, the component extraction unit 17, and the update determination unit 18.

### Physical Configuration

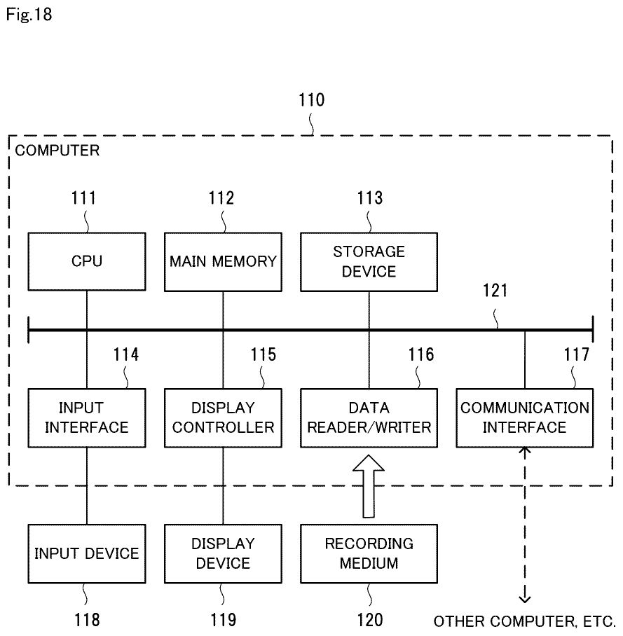

Here, a computer that realizes the system verification apparatus by executing the program according to the first and second example embodiments will be described with reference to FIG. 18. FIG. 18 is a diagram for describing an example of a computer that realizes the system verification apparatus in the first and second example embodiments.

As shown in FIG. 18, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the system verification apparatus according to the first and second example embodiments can also be realized by using hardware corresponding to each unit. Furthermore, a portion of the system verification apparatus may be realized by a program, and the remaining portion realized by hardware.

Supplementary note

Furthermore, the following supplementary notes are disclosed regarding the first and second example embodiments described above. Some portion or all of the example embodiments described above can be realized according to (supplementary note 1) to (supplementary note 12) described below, but the below description does not limit the present invention.

### Supplementary Note 1

A system verification apparatus comprising:
a performance-prediction-formula generating unit that generates a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
a verification-result determining unit that calculates a performance prediction value corresponding to the quantitative requirement using the performance prediction formula and a performance measurement value to be used in the performance prediction formula, and determining whether or not the calculated performance prediction value satisfies the performance defined by the abstract portion.

### Supplementary Note 2

The system verification apparatus according to Supplementary note 1 further comprising:
a verification-environment constructing unit that constructs a verification environment defined by the concrete system configuration if the performance-prediction-formula generating means cannot acquire the performance measurement value;
a verification-program generating unit that generates a verification program for executing performance measurement processing in the verification environment; and
a verification-program executing unit that outputs an execution result of the verification program.

### Supplementary Note 3

The system verification apparatus according to Supplementary note 2 further comprising:
a component extracting unit that acquires, with a certain probability, the concrete system configuration acquired by the performance-prediction-formula generating unit, and extracts one of components included in the acquired concrete system configuration; and
an update determining unit that updates, if a relationship between the performance measurement value corresponding to the quantitative requirement of the component included in the execution result of the verification program executed by the verification-program executing unit and a performance measurement value corresponding to the quantitative requirement of the component included in performance measurement information in advance meet a predefined update criterion, the performance measurement value included in the performance measurement information with the performance measurement value corresponding to the quantitative requirement of the acquired component.

### Supplementary Note 4

The system verification apparatus according to any one of Supplementary notes 1 to 3 further comprising
an output-information generating unit that outputs, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.

### Supplementary Note 5

A system verification method,
wherein a computer:
   generates a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
   calculates a performance prediction value corresponding to the quantitative requirement using the performance prediction formula and a performance measurement value to be used in the performance prediction formula, and determines whether or not the calculated performance prediction value satisfies the performance defined by the abstract portion.

### Supplementary Note 6

The system verification method according to Supplementary note 5,
wherein the computer further:
   constructs a verification environment defined by the concrete system configuration if the performance measurement value cannot be acquired;
   generates a verification program for executing performance measurement processing in the verification environment; and
   outputs an execution result of the verification program.

### Supplementary Note 7

The system verification method according to Supplementary note 6,
wherein the computer further:
   acquires the concrete system configuration with a certain probability, and extracts one of components included in the acquired concrete system configuration; and
   if a relationship between the performance measurement value corresponding to the quantitative requirement of the component included in the execution result of the verification program and a performance measurement value corresponding to the quantitative requirement of the component included in performance measurement information in advance meet a predefined update criterion, updates the performance measurement value included in the performance measurement information with the performance measurement value corresponding to the quantitative requirement of the acquired component.

### Supplementary Note 8

The system verification method according to any one of Supplementary notes 5 to 7,
wherein the computer further
   outputs, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.

### Supplementary Note 9

A computer readable recording medium that includes a program recorded thereon, the program including instructions that cause a computer to:
generate a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculate a performance prediction value corresponding to the quantitative requirement using the performance prediction formula and a performance measurement value to be used in the performance prediction formula, and determine whether or not the calculated performance prediction value satisfies the performance defined by the abstract portion.

### Supplementary Note 10

The computer readable recording medium according to Supplementary note 9,
wherein the program further includes instructions that cause the computer to:
   construct a verification environment defined by the concrete system configuration if the performance measurement value cannot be acquired;
   generate a verification program for executing performance measurement processing in the verification environment; and
   output an execution result of the verification program.

### Supplementary Note 11

The computer readable recording medium according to Supplementary note 10,
wherein the program further includes instructions that cause the computer to:
   acquire the concrete system configuration with a certain probability, and extract one of components included in the acquired concrete system configuration; and
if a relationship between the performance measurement value corresponding to the quantitative requirement of the component included in the execution result of the verification program and a performance measurement value corresponding to the quantitative requirement of the component included in performance measurement information in advance meet a predefined update criterion, update the performance measurement value included in the performance measurement information with the performance measurement value corresponding to the quantitative requirement of the acquired component.

### Supplementary Note 12

The computer readable recording medium according to any one of Supplementary notes 9 to 11,
wherein the program further includes instructions that cause the computer to:
   output, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention.

### INDUSTRIAL APPLICABILITY

According to the disclosure above, the time required to verify an ICT system can be reduced. Furthermore, the present invention is useful in fields in which ICT systems are designed automatically.

### REFERENCE SIGNS LIST

10 System verification apparatus
11 Performance-prediction-formula generation unit
12 Verification-result determination unit
13 Verification-environment construction unit
14 Verification-program generation unit
15 Verification-program execution unit
16 Output-information generation unit
17 Component extraction unit
18 Update determination unit
20 Storage device
30 Input device
40 Output device
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A system verification apparatus comprising:
at least one memory storing instructions; and
at least one processor configured to execute the instructions to:
generate a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculate performance prediction value corresponding to the quantitative requirement using the performance prediction formula and a performance measurement value to be used in the performance prediction formula, and determine whether or not the calculated performance prediction value satisfies the performance defined by the abstract portion.

2. The system verification apparatus according to claim 1,
wherein the one or more processors further:
constructs a verification environment defined by the concrete system configuration if the performance measurement value cannot be acquired;
generate a verification program for executing performance measurement processing in the verification environment; and
outputs an execution result of the verification program.

3. The system verification apparatus according to claim 2,
wherein the one or more processors further:
acquires the concrete system configuration with a certain probability, and extracts one of components included in the acquired concrete system configuration; and
if a relationship between the performance measurement value corresponding to the quantitative requirement of the component included in the execution result of the verification program and a performance measurement value corresponding to the quantitative requirement of the component included in performance measurement information in advance meet a predefined update criterion, updates the performance measurement value included in the performance measurement information with the performance measurement value corresponding to the quantitative requirement of the acquired component.

4. The system verification apparatus according to claim 1,
wherein the one or more processors further:
outputs, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.

5. A system verification method,
wherein a computer:
generates a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculates a performance prediction value corresponding to the quantitative requirement using the performance prediction formula and a performance measurement value to be used in the performance prediction formula, and determines whether or not the calculated performance prediction value satisfies the performance defined by the abstract portion.

6. The system verification method according to claim 5,
wherein the computer further:
constructs a verification environment defined by the concrete system configuration if the performance measurement value cannot be acquired;
generates a verification program for executing performance measurement processing in the verification environment; and
outputs an execution result of the verification program.

7. The system verification method according to claim 6,
wherein the computer further:
acquires the concrete system configuration with a certain probability, and extracts one of components included in the acquired concrete system configuration; and
if a relationship between the performance measurement value corresponding to the quantitative requirement of the component included in the execution result of the verification program and a performance measurement value corresponding to the quantitative requirement of the component included in performance measurement information in advance meet a predefined update criterion, updates the performance measurement value included in the performance measurement information with the performance measurement value corresponding to the quantitative requirement of the acquired component.

8. The system verification method according to claim 5,
wherein the computer further
outputs, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.

9. A non-transitory computer readable recording medium that includes a program recorded thereon, the program including instructions that cause a computer to:
generate a performance prediction formula for determining whether or not, in a concrete system configuration obtained by concretizing system requirements including an abstract portion, a performance of a concrete portion that is obtained by concretizing the abstract portion satisfies a performance defined by the abstract portion based on information set in advance with respect to a quantitative requirement of components included in the concrete portion; and
calculate a performance prediction value corresponding to the quantitative requirement using the performance prediction formula and a performance measurement value to be used in the performance prediction formula, and determine whether or not the calculated performance prediction value satisfies the performance defined by the abstract portion.

10. The non-transitory computer readable recording medium according to claim 9,
wherein the program further includes instructions that cause the computer to:
construct a verification environment defined by the concrete system configuration if the performance measurement value cannot be acquired;
generate a verification program for executing performance measurement processing in the verification environment; and
output an execution result of the verification program.

11. The non-transitory computer readable recording medium according to claim 10,
wherein the program further includes instructions that cause the computer to:
acquire the concrete system configuration with a certain probability, and extract one of components included in the acquired concrete system configuration; and
if a relationship between the performance measurement value corresponding to the quantitative requirement of the component included in the execution result of the verification program and a performance measurement value corresponding to the quantitative requirement of the component included in performance measurement information in advance meet a predefined update criterion, update the performance measurement value included in the performance measurement information with the performance measurement value corresponding to the quantitative requirement of the acquired component.

12. The non-transitory computer readable recording medium according to claim 9,
wherein the program further includes instructions that cause the computer to:
output, to an output device, a user interface including: an input form for creating the system requirements; an output form that displays the concrete system configuration obtained by concretizing the system requirements; and a detailed-information display section that displays information indicating the components and a relationship between the components included in the system requirements and the concrete system configuration.
